(19) United States
(12) Patent Application Publication
(10) Pub. No.: US 2026/0015908 A1
(43) Pub. Date: Jan. 15, 2026

(54) TELESCOPIC LADDER

(71) Applicant: Zhejiang Yongan Deli Industry and Trade Co., Ltd., Jinhua (CN)

(72) Inventor: Anmin Ye, Yongkang (CN)

(21) Appl. No.: 19/338,003

(22) Filed: Sep. 24, 2025

(30) Foreign Application Priority Data
Sep. 28, 2024 (CN) 202422373601.9

(51) Int. Cl. E06C 1/12

(52) U.S. Cl. CPC E06C 1/125

(57) ABSTRACT

A telescopic ladder includes a ladder body, and the ladder body includes a plurality of layers of left ladder tubes and right ladder tubes sleeved with each other. The upper left ladder tube and the upper right ladder tube are sequentially sleeved in the lower left ladder tube and the lower right ladder tube respectively, each layer of the left ladder tube and the right ladder tube is provided with a crossbar pedal, and both ends of the crossbar pedal on each layer are connected to the left ladder tube and the right ladder tube on each layer. The telescopic ladder has a simple structure, and when the telescopic ladder is pulled open, the user clearly observes the stability of internal snap-fitted engagement.

### TECHNICAL FIELD

The present disclosure belongs to the technical field of ladders, and particularly relates to a telescopic ladder.

### BACKGROUND

Ladders are common tools for climbing to heights. For the convenience of carrying, a ladder in the prior art is generally designed as a telescopic ladder, in which large tubes are arranged to be sleeved over small tubes. Before use, each tube is pulled apart to extend a length. Compared with an integrated ladder of fixed length, an extendable telescopic ladder requires more stability and safety. To enhance safety of the telescopic ladder currently available on the market, an insertion rod and a button are usually arranged on inner and outer sides of a pedal, a vertical rod is provided with an insertion hole, and the button is controlled to drive the insertion rod to move. When the insertion rod is snap-fitted with the insertion hole, the vertical rod is restricted from moving downward. In this case, when the user steps on the pedal, the user will not move downward. However, in this way of use, the user needs to pay special attention to whether the insertion rod is properly snap-fitted with the insertion hole. When the user pushes the button to drive the insertion rod to move, since the insertion rod is located in the pedal, the user does not know how far the insertion rod has moved or whether full snap-fitted engagement is achieved. When the user steps on the unstable pedal without sufficient snap-fitted engagement, the pedal easily moves downward due to the weight of the user, and the sudden height drop easily causes the user to fall. In particular, when the telescopic ladder available on the market is opened, the button needs to be operated repeatedly to pull open each pedal. This mechanical repetition is more likely to be neglected by the user. Therefore, there is a need for a telescopic ladder that enables the user to clearly observe the stability of internal snap-fitted engagement when the telescopic ladder is pulled open.

### SUMMARY

An objective of the present disclosure is to provide a telescopic ladder with a simple structure, which enables the user to clearly observe the stability of internal snap-fitted engagement when the telescopic ladder is pulled open.

The objective of the present disclosure is implemented as follows:

A telescopic ladder, including a ladder body, where the ladder body includes a plurality of layers of left ladder tubes and right ladder tubes sleeved with each other, the upper left ladder tube and the upper right ladder tube are sequentially sleeved in the lower left ladder tube and the lower right ladder tube respectively, each layer of the left ladder tube and the right ladder tube is provided with a crossbar pedal, and both ends of the crossbar pedal on each layer are connected to the left ladder tube and the right ladder tube on each layer;
a locking assembly is arranged in the crossbar pedal, and the locking assembly includes an insertion rod movably arranged in the crossbar pedal and abutting against outer walls of the left ladder tube and the right ladder tube, an elastic member with one end connected to the insertion rod, and a hook member movably connected to the insertion rod, where the hook member is partially exposed on a lower surface of the crossbar pedal; a rotating groove is formed in the crossbar pedal, the hook member is provided with a rotating rod in a protruding manner, the hook member is arranged in the rotating groove through the rotating rod and rotates around the rotating rod, an upper end of the hook member is connected to the insertion rod and drives the insertion rod to move transversely outward or inward through rotation, and an insertion portion is arranged at a lower end of the hook member; a connecting part is arranged at an upper end of the crossbar pedal in a protruding manner, and an insertion slot is formed on the connecting part; when the upper left ladder tube and the upper right ladder tube move downward to be sleeved into the lower left ladder tube and the lower right ladder tube, the hook member rotates to drive the insertion portion to insert into the insertion slot, and in this case, the insertion rod in the lower crossbar pedal abuts against the outer walls of the upper left ladder tube and the upper right ladder tube, thereby preventing the insertion portion from disengaging from the insertion slot; an abutment portion is further arranged at a lower end of the hook member, after the upper left ladder tube and the upper right ladder tube move downward, the abutment portion on the upper hook member in the upper crossbar pedal abuts against the connecting part on the lower crossbar pedal, the upper crossbar pedal continues to move downward, and in this case, the connecting part on the lower crossbar pedal pushes the abutment portion of the upper hook member to rotate inward; in this case, the hook member in the upper crossbar pedal rotates around the rotating rod and drives the insertion portion to insert into the insertion slot in the connecting part of the lower crossbar pedal, and the insertion rod, driven by the rotation of the upper end of the hook member, moves transversely inward to mechanically compress the elastic member; and
lower insertion holes are formed at lower ends of the left ladder tube and the right ladder tube, when the upper crossbar pedal is pulled upward, the upper left ladder tube and the upper right ladder tube move upward, when the lower insertion holes at the lower ends of the upper left ladder tube and the upper right ladder tube are flush with the insertion rod in the lower crossbar pedal, the insertion rod in the lower crossbar pedal is released, moves outward, and is inserted into the lower insertion hole, the hook member rotates around the rotating rod and drives the insertion portion to disengage from the insertion slot, and in this case, the upper crossbar pedal is pulled away from the lower crossbar pedal.

Further, a snap-fit portion is arranged at a middle of the insertion rod, a diameter of the snap-fit portion is smaller than a diameter of both ends of the insertion rod, clamping portions are arranged at the upper end of the hook member, the number of the clamping portions is two, and the two clamping portions are arranged adjacent to each other and clamp the snap-fit portion.

Further, the hook member is further provided with a pushing portion, and when the clamping portion is connected to the snap-fit portion, the pushing portion abuts against the insertion rod; when the abutment portion on the upper crossbar pedal is pushed by the connecting part on the lower crossbar pedal, the hook member rotates together with the rotating rod and pushes the insertion rod to move inward through the pushing portion; and in this case, one end of the insertion rod is disengaged from the lower insertion hole.

Further, a sliding inclined surface is further arranged at an upper end of the connecting part, a sliding surface is further arranged between the abutment portion and the insertion portion, and when the connecting part on the lower crossbar pedal pushes the abutment portion on the upper hook member to rotate inward, the sliding surface is in contact with the sliding inclined surface.

Further, the crossbar pedal is provided with a mounting groove, a mounting base is arranged in the mounting groove, a mounting hole is formed on the mounting base, and one end of the elastic member and one end of the insertion rod are arranged in the mounting hole, where one end of the elastic member abuts against the mounting hole, and the other end thereof abuts against the end portion of the insertion rod; when the left ladder tube and the right ladder tube move upward and the lower insertion holes on the left ladder tube and the right ladder tube are flush with the insertion rod, the elastic member pushes the insertion rod to move outward and insert into the lower insertion hole; in this case, the upper left ladder tube and the upper right ladder tube cannot move into the lower left ladder tube and the lower right ladder tube; and the elastic member is a spring.

Further, an upper pull rod is arranged above the ladder body, the left ladder tube and the right ladder tube on both sides of the upper pull rod are arranged in the left ladder tube and the right ladder tube on both sides of the lower crossbar pedal, and the left ladder tube and the right ladder tube on both sides of the upper pull rod are driven to move upward by pulling the upper pull rod upward. When the lower insertion holes at the lower ends of the left ladder tube and the right ladder tube on both sides of the upper pull rod are flush with the insertion rod in the lower crossbar pedal, the insertion rod of the lower crossbar pedal moves outward and is inserted into the lower insertion holes.

Further, a lower base rod is further arranged below the ladder body, the locking assembly is further arranged in the lower base rod, and a rotating member in the lower base rod is manually driven to rotate so as to drive the insertion rod to move transversely inward; in this case, the insertion rod is disengaged from the lower insertion holes of the left ladder tube and the right ladder tube on an upper layer of the lower base rod; and in this case, the upper crossbar pedal moves downward along with the left ladder tube and the right ladder tube on both sides.

Compared with the prior art, the present disclosure has the following outstanding and beneficial technical effects:

The present disclosure provides a telescopic ladder. According to a previous telescopic ladder structure, the insertion rod is snap-fitted with the ladder tube to restrict descent of the ladder tube. In use, the user needs to press a switch of each layer to control the movement of the insertion rod of each layer. Since the left ladder tube and the right ladder tube are arranged at each layer, the user needs to press the insertion rods on both sides to achieve snap-fitted engagement with the left ladder tube and the right ladder tube. However, since excessively numerous operations are required and the internal snap-fitted engagement situation is unknown, once the full snap-fitted engagement is not achieved, when the user steps on the crossbar pedal, the crossbar pedal moves downward due to the weight effect, and in this case, the user may fall. When the user moves the insertion rod for many times, the insertion rod is positionally misaligned in the crossbar pedal, and the user easily mistakenly believes that the two have been snap-fitted in the case of insufficient insertion. Or after the elastic member in the crossbar pedal is compressed and released for a long time, elasticity of the elastic member is weaker significantly than before. The user cannot feel a moving distance of the insertion rod, and maybe only an end portion of the insertion rod is slightly inserted into the lower insertion hole. In order to enhance the safety of the present disclosure, the hook member is arranged on the insertion rod, the insertion portion is arranged on the hook member, and the hook member is rotatably connected to the crossbar pedal. When the hook member rotates through the rotating rod, the lower insertion portion rotates in an arc direction. In the present disclosure, the connecting part is further arranged on an upper surface of the crossbar pedal in a protruding manner, and the connecting part is provided with the insertion slot corresponding to the insertion portion. When the hook member rotates, the insertion portion rotates together with the hook member and is inserted into the insertion slot, and in this case, the insertion rod moves transversely inward with the rotation, and both ends of the insertion rod are disengaged from the lower insertion holes of the left ladder tube and the right ladder tube. In this case, the upper left ladder tube and the upper right ladder tube move downward to be sleeved in the lower left ladder tube and the lower right ladder tube, and both ends of the insertion rod in the lower crossbar pedal abut against outer walls of lower ends of the upper left ladder tube and the upper right ladder tube and cannot move, such that the insertion rod cannot move, the insertion portion is not disengaged from the insertion slot, and the upper crossbar pedal and the lower crossbar pedal keep close to each other and are not far away from each other. When the upper left ladder tube and the upper right ladder tube move upward, the lower ends of the upper left ladder tube and the upper right ladder tube are flush with the insertion rod in the lower crossbar pedal, and in this case, the insertion rod in the lower crossbar pedal is inserted into the lower insertion hole, and the hook member on the lower crossbar pedal rotates together with the insertion rod and drives the insertion portion to disengage from the insertion slot on the lower crossbar pedal. In this case, the lower crossbar pedal is further pulled upward, the present disclosure is locked through the connection of the upper crossbar pedal and the lower crossbar pedal layer by layer, and only when the upper crossbar pedal is unlocked, the lower crossbar pedal is pulled upward. When the lower insertion holes at the lower ends of the upper left ladder tube and the upper right ladder tube are not flush with the insertion rod in the lower crossbar pedal, the insertion portion on the lower crossbar pedal is always fixed in the insertion slot and cannot move, and the lower crossbar pedal cannot move upward. The user only needs to determine whether the insertion rod is located in the lower insertion hole according to whether the upper and lower crossbar pedals can be pulled, thereby enhancing the safety. Without need to worry about the snap-fitted engagement situation of each ladder layer, the user only needs to pull an uppermost layer to open the telescopic ladder, and select layers of the lower crossbar pedals to be pulled open according to needs, without need to pull open each layer, that is, direct one-time pulling offers more convenience. In the present disclosure, the lower insertion holes are formed at the lower ends of the left ladder tube and the right ladder tube, through holes are further formed at upper ends thereof, and when the upper left ladder tube and the upper right ladder tube sleeved with the lower left ladder tube and the lower right ladder tube are pulled open, the lower insertion holes at the lower ends of the upper left ladder tube and the upper right ladder tube are flush with the through holes at the upper ends of the lower left ladder tube and the lower right ladder tube and are inserted by the insertion rod in the crossbar pedal.

### BRIEF DESCRIPTION OF THE DRAWINGS

FIG. 1 is a perspective view of the present disclosure.

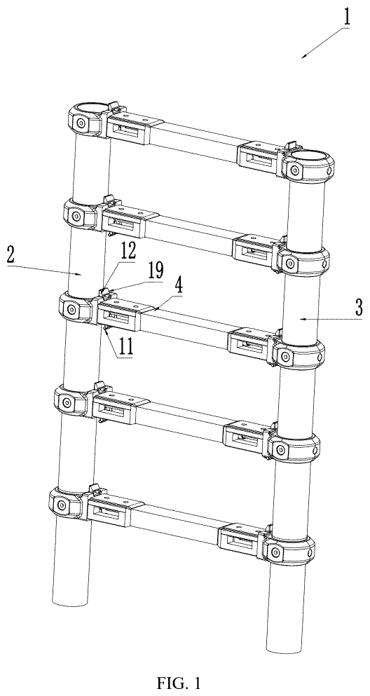

FIG. 2 is a front view of the present disclosure.

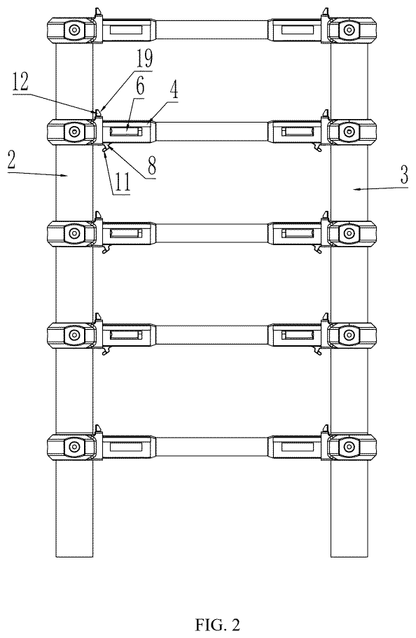

FIG. 3 is an exploded view of the present disclosure.

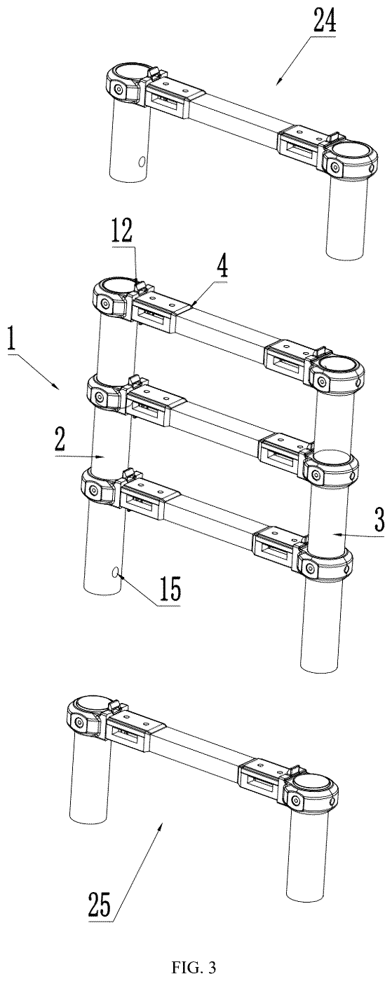

FIG. 4 is a perspective view of a left ladder tube, a crossbar pedal, and a right ladder tube on a single layer of the present disclosure.

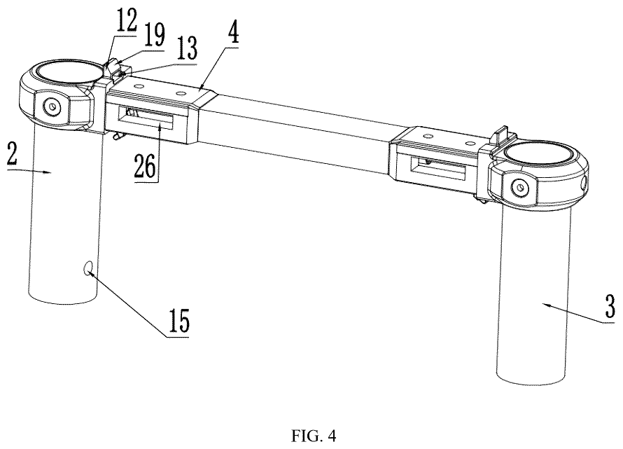

FIG. 5 is an exploded view of a left ladder tube, a crossbar pedal, and a right ladder tube on a single layer of the present disclosure.

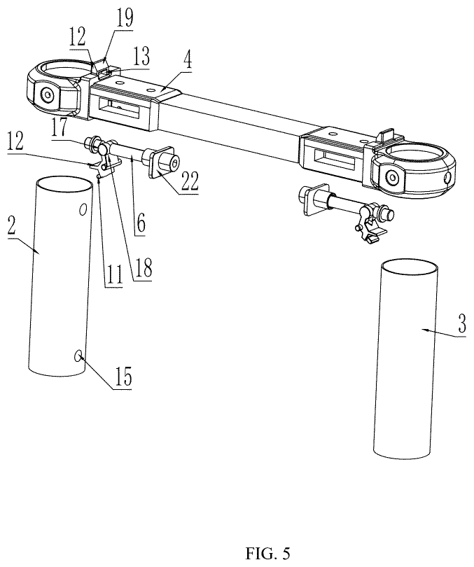

FIG. 6 is a schematic diagram I of a crossbar pedal of the present disclosure.

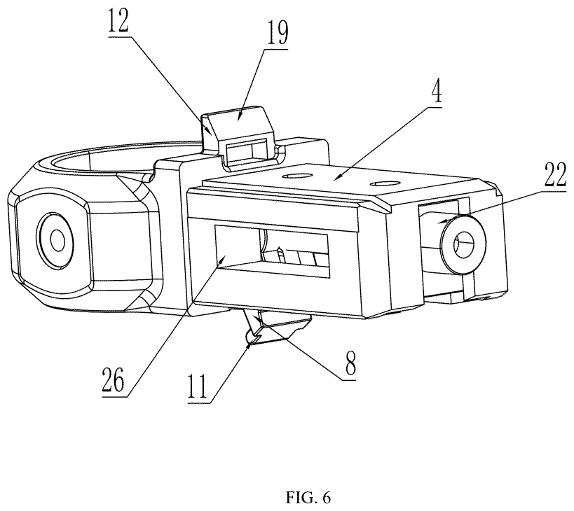

FIG. 7 is a schematic diagram II of a crossbar pedal of the present disclosure.

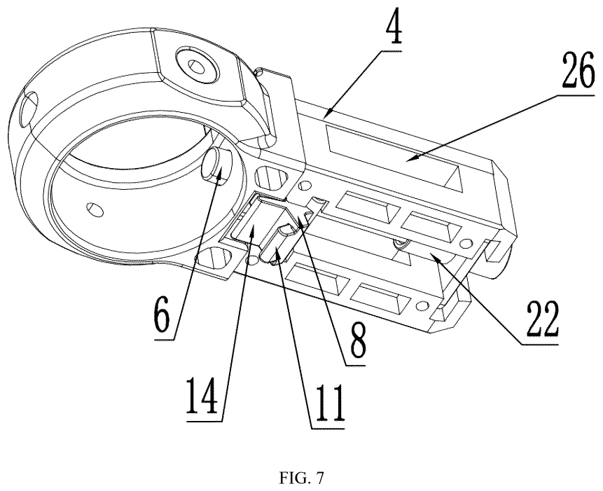

FIG. 8 is an exploded view of a crossbar pedal of the present disclosure.

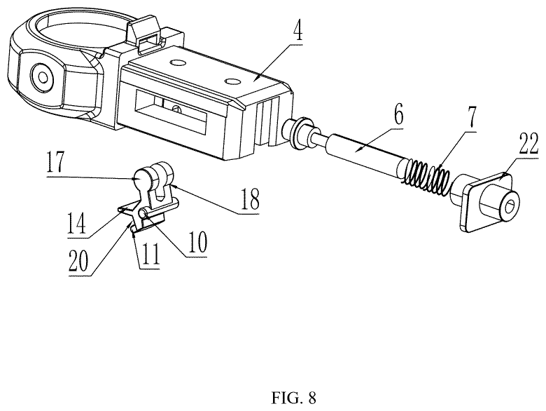

FIG. 9 is a side view of a locking assembly of the present disclosure.

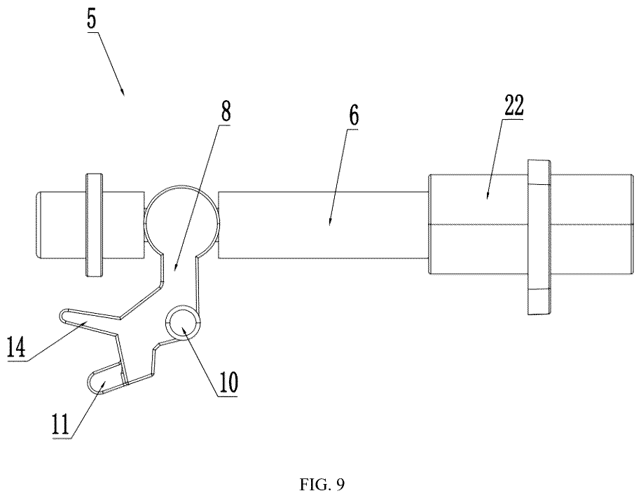

FIG. 10 is a schematic diagram of a partial structure of a crossbar pedal of the present disclosure.

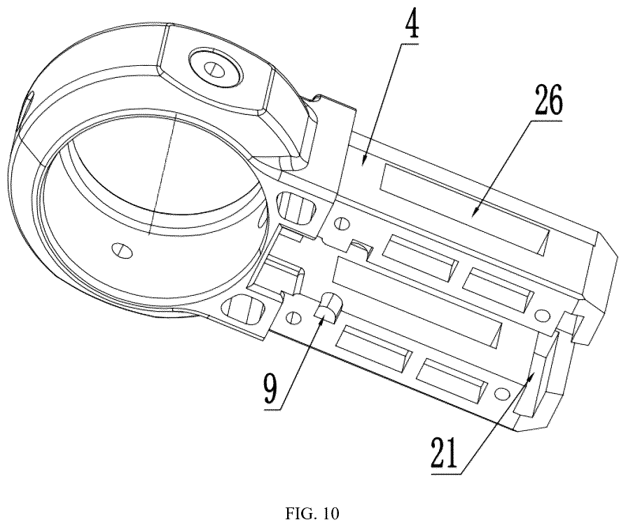

FIG. 11 is a schematic diagram of connection between an upper crossbar pedal and a lower crossbar pedal of the present disclosure.

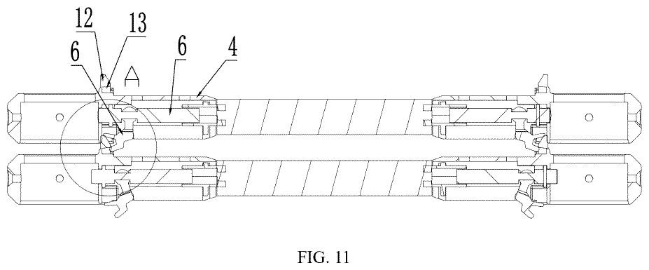

FIG. 12 is a partial enlarged view of a portion A in FIG. 11.

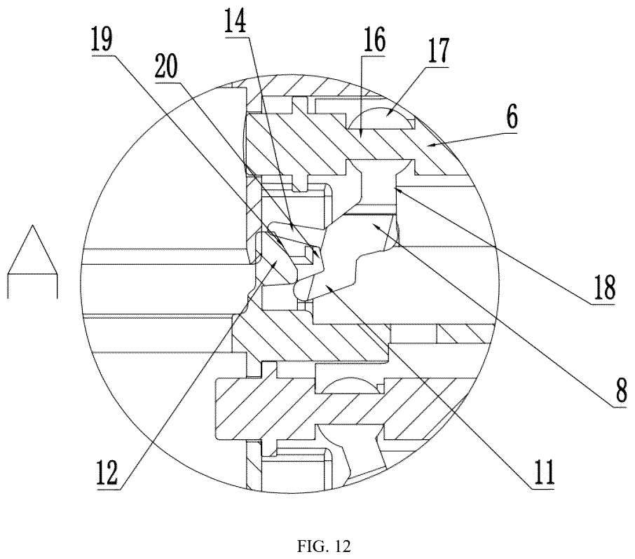

FIG. 13 is a sectional view of an upper pull rod of the present disclosure.

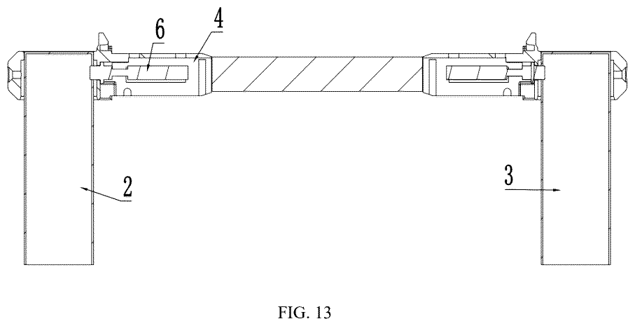

FIG. 14 is a schematic diagram of the present disclosure after folding.

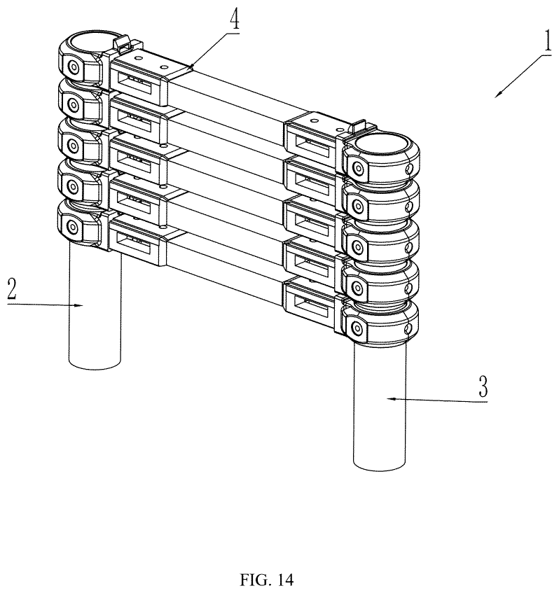

FIG. 15 is a front view of the present disclosure after folding.

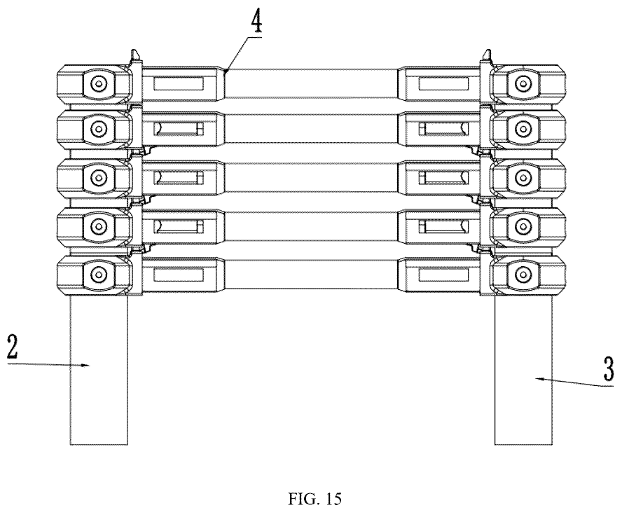

Reference numerals in the figures:
1—ladder body; 2—left ladder tube; 3—right ladder tube; 4—crossbar pedal; 5—locking assembly; 6—insertion rod; 7—elastic member; 8—hook member; 9—rotating groove; 10—rotating rod; 11—insertion portion; 12—connecting part; 13—insertion slot; 14—abutment portion; 15—lower insertion hole; 16—snap—fit portion; 17—clamping portion; 18—pushing portion; 19—sliding inclined surface; 20—sliding surface; 21—mounting groove; 22—mounting base; 24—upper pull rod; 25—lower base rod; and 26—observation window.

### DETAILED DESCRIPTIONS OF THE EMBODIMENTS

The present disclosure is further described below in combination with specific examples:

A telescopic ladder includes a ladder body 1, the ladder body 1 includes a plurality of layers of left ladder tubes 2 and right ladder tubes 3 sleeved with each other, the upper left ladder tube 2 and the upper right ladder tube 3 are sequentially sleeved in the lower left ladder tube 2 and the lower right ladder tube 3 respectively, each layer of the left ladder tube 2 and the right ladder tube 3 is provided with a crossbar pedal 4, and both ends of the crossbar pedal 4 on each layer are connected to the left ladder tube 2 and the right ladder tube 3 on each layer;
a locking assembly 5 is arranged in the crossbar pedal 4, and the locking assembly 5 includes an insertion rod 6 movably arranged in the crossbar pedal 4 and abutting against outer walls of the left ladder tube 2 and the right ladder tube 3, an elastic member 7 with one end connected to the insertion rod 6, and a hook member 8 movably connected to the insertion rod 6, where the hook member 8 is partially exposed on a lower surface of the crossbar pedal 4; a rotating groove 9 is formed in the crossbar pedal 4, the hook member 8 is provided with a rotating rod 10 in a protruding manner, the hook member 8 is arranged in the rotating groove 9 through the rotating rod 10 and rotates around the rotating rod 10, an upper end of the hook member 8 is connected to the insertion rod 6 and drives the insertion rod 6 to move transversely outward or inward through rotation, and an insertion portion 11 is arranged at a lower end of the hook member 8; a connecting part 12 is arranged at an upper end of the crossbar pedal 4 in a protruding manner, and an insertion slot 13 is formed on the connecting part 12; when the upper left ladder tube 2 and the upper right ladder tube 3 move downward to be sleeved into the lower left ladder tube 2 and the lower right ladder tube 3, the hook member 8 rotates to drive the insertion portion 11 to insert into the insertion slot 13, and in this case, the insertion rod 6 in the lower crossbar pedal 4 abuts against the outer walls of the upper left ladder tube 2 and the upper right ladder tube 3, thereby preventing the insertion portion 11 from disengaging from the insertion slot 13; an abutment portion 14 is further arranged at a lower end of the hook member 8, after the upper left ladder tube 2 and the upper right ladder tube 3 move downward, the abutment portion 14 on the hook member 8 in the upper crossbar pedal 4 abuts against the connecting part 12 on the lower crossbar pedal 4, the upper crossbar pedal 4 continues to move downward, and in this case, the connecting part 12 on the lower crossbar pedal 4 pushes the abutment portion 14 of the upper hook member 8 to rotate inward; in this case, the hook member 8 in the upper crossbar pedal 4 rotates around the rotating rod 10 and drives the insertion portion 11 to insert into the insertion slot 13 in the connecting part 12 of the lower crossbar pedal 4, and the insertion rod 6, driven by the rotation of the upper end of the hook member 8, moves transversely inward to mechanically compress the elastic member 7; and
lower insertion holes 15 are formed at lower ends of the left ladder tube 2 and the right ladder tube 3, when the upper crossbar pedal 4 is pulled upward, the upper left ladder tube 2 and the upper right ladder tube 3 move upward, when the lower insertion holes 15 at the lower ends of the upper left ladder tube 2 and the upper right ladder tube 3 are flush with the insertion rod 6 in the lower crossbar pedal 4, the insertion rod 6 in the lower crossbar pedal 4 is released, moves outward, and is inserted into the lower insertion hole 15, the hook member 8 rotates around the rotating rod 10 and drives the insertion portion 11 to disengage from the insertion slot 13, and in this case, the upper crossbar pedal 4 may be pulled away from the lower crossbar pedal 4.

The present disclosure provides a telescopic ladder. According to a previous telescopic ladder structure, the insertion rod 6 is snap-fitted with the ladder tube to restrict descent of the ladder tube. In use, the user needs to press a switch of each layer to control the movement of the insertion rod 6 of each layer. Since the left ladder tube 2 and the right ladder tube 3 are arranged at each layer, the user needs to press the insertion rods 6 on both sides to achieve snap-fitted engagement with the left ladder tube 2 and the right ladder tube 3. However, since excessively numerous operations are required and the internal snap-fitted engagement situation is unknown, once the full snap-fitted engagement is not achieved, when the user steps on the crossbar pedal 4, the crossbar pedal 4 moves downward due to the weight effect, and in this case, the user may fall. When the user moves the insertion rod 6 for many times, the insertion rod 6 is positionally misaligned in the crossbar pedal 4, and the user easily mistakenly believes that the two have been snap-fitted in the case of insufficient insertion. Or after the elastic member 7 in the crossbar pedal 4 is compressed and released for a long time, elasticity of the elastic member is weaker significantly than before. The user cannot feel a moving distance of the insertion rod 6, and maybe only an end portion of the insertion rod 6 is slightly inserted into the lower insertion hole 15. In order to enhance the safety of the present disclosure, the hook member 8 is arranged on the insertion rod 6, the insertion portion 11 is arranged on the hook member 8, and the hook member 8 is rotatably connected to the crossbar pedal 4. When the hook member 8 rotates through the rotating rod 10, the lower insertion portion 11 rotates in an arc direction. In the present disclosure, the connecting part 12 is further arranged on an upper surface of the crossbar pedal 4 in a protruding manner, and the connecting part 12 is provided with the insertion slot 13 corresponding to the insertion portion 11. When the hook member 8 rotates, the insertion portion 11 rotates together with the hook member 8 and is inserted into the insertion slot 13, and in this case, the insertion rod 6 moves transversely inward with the rotation, and both ends of the insertion rod 6 are disengaged from the lower insertion holes 15 of the left ladder tube 2 and the right ladder tube 3. In this case, the upper left ladder tube 2 and the upper right ladder tube 3 move downward to be sleeved in the lower left ladder tube 2 and the lower right ladder tube 3, and both ends of the insertion rod 6 in the lower crossbar pedal 4 abut against outer walls of lower ends of the upper left ladder tube 2 and the upper right ladder tube 3 and cannot move, such that the insertion rod 6 cannot move, and the insertion portion 11 is not disengaged from the insertion slot 13, and the upper crossbar pedal 4 and the lower crossbar pedal 4 keep close to each other and are not far away from each other. When the upper left ladder tube 2 and the upper right ladder tube 3 move upward, the lower ends of the upper left ladder tube 2 and the upper right ladder tube 3 are flush with the insertion rod 6 in the lower crossbar pedal 4, and in this case, the insertion rod 6 in the lower crossbar pedal 4 is inserted into the lower insertion hole 15, and the hook member 8 on the lower crossbar pedal 4 rotates together with the insertion rod 6 and drives the insertion portion 11 to disengage from the insertion slot 13 on the lower crossbar pedal 4. In this case, the lower crossbar pedal 4 is further pulled upward, the present disclosure is locked through the connection of the upper crossbar pedal 4 and the lower crossbar pedal 4 layer by layer, and only when the upper crossbar pedal 4 is unlocked, the lower crossbar pedal 4 is pulled upward. When the lower insertion holes 15 at the lower ends of the upper left ladder tube 2 and the upper right ladder tube 3 are not flush with the insertion rod 6 in the lower crossbar pedal 4, the insertion portion 11 on the lower crossbar pedal 4 is always fixed in the insertion slot 13 and cannot move, and the lower crossbar pedal 4 cannot move upward. The user only needs to determine whether the insertion rod 6 is located in the lower insertion hole 15 according to whether the upper and lower crossbar pedals 4 can be pulled, thereby enhancing the safety. Without need to worry about the snap-fitted engagement situation of each ladder layer, the user only needs to pull an uppermost layer to open the telescopic ladder, and select layers of the lower crossbar pedals 4 to be pulled open according to needs, without need to pull open each layer, that is, direct one-time pulling offers more convenience. In the present disclosure, the lower insertion holes 15 are formed at the lower ends of the left ladder tube 2 and the right ladder tube 3, through holes are further formed at upper ends thereof, and when the upper left ladder tube 2 and the upper right ladder tube 3 sleeved with the lower left ladder tube 2 and the lower right ladder tube 3 are pulled open, the lower insertion holes 15 at the lower ends of the upper left ladder tube 2 and the upper right ladder tube 3 are flush with the through holes at the upper ends of the lower left ladder tube 2 and the lower right ladder tube 3 and are inserted by the insertion rod 6 in the crossbar pedal 4.

Preferably, a snap-fit portion 16 is arranged at a middle of the insertion rod 6, a diameter of the snap-fit portion 16 is smaller than a diameter of both ends of the insertion rod 6, clamping portions 17 are arranged at the upper end of the hook member 8, the number of the clamping portions 17 is two, and the two clamping portions 17 are arranged adjacent to each other and clamp the snap-fit portion 16, such that the snap-fit portion 16 and the clamping portion 17 are better snap-fitted with each other, and when the user drives the hook member 8 to rotate, the clamping portions 17 drive the snap-fit portion 16 to rotate so as to cause the insertion rod 6 to move transversely.

Preferably, the hook member 8 is further provided with a pushing portion 18, and when the clamping portion 17 is connected to the snap-fit portion 16, the pushing portion 18 abuts against the insertion rod 6. When the abutment portion 14 on the upper crossbar pedal 4 is pushed by the connecting part 12 on the lower crossbar pedal 4, the hook member 8 rotates together with the rotating rod 10 and pushes the insertion rod 6 to move inward through the pushing portion 18. In this case, one end of the insertion rod 6 is disengaged from the lower insertion hole 15, such that the insertion rod 6 is pushed to move when the user drives the hook member 8 to rotate. When the clamping portion 17 is snap-fitted with the snap-fit portion 16, a surface of the pushing portion 18 abuts against a surface generated by the diameter difference between the snap-fit portion 16 and the insertion rod 6, which prevents the user from manually pulling the insertion rod 6 to move. When the hook member 8 rotates, the upper end of the hook member 8 rotates backward to naturally push the insertion rod 6 to move through the pushing portion 18.

Preferably, a sliding inclined surface 19 is further arranged at an upper end of the connecting part 12, a sliding surface 20 is further arranged between the abutment portion 14 and the insertion portion 11, and when the connecting part 12 on the lower crossbar pedal 4 pushes the abutment portion 14 on the hook member 8 to rotate inward, the sliding surface 20 is in contact with the sliding inclined surface 19, such that the hook member 8 rotates smoothly after the connecting part 12 pushes the abutment portion 14 to rotate.

Preferably, the crossbar pedal 4 is provided with a mounting groove 21, a mounting base 22 is arranged in the mounting groove 21, a mounting hole is formed on the mounting base 22, and one end of the elastic member 7 and one end of the insertion rod 6 are arranged in the mounting hole, where one end of the elastic member 7 abuts against the mounting hole, and the other end thereof abuts against the end portion of the insertion rod 6. When the left ladder tube 2 and the right ladder tube 3 move upward and the lower insertion holes 15 on the left ladder tube 2 and the right ladder tube 3 are flush with the insertion rod 6, the elastic member 7 pushes the insertion rod 6 to move outward and insert into the lower insertion hole 15. In this case, the upper left ladder tube 2 and the upper right ladder tube 3 cannot move into the lower left ladder tube 2 and the lower right ladder tube 3. The elastic member 7 is a spring. Before the ladder body 1 is contracted, end portions of the two insertion rods 6 in the crossbar pedal 4 respectively abut against the outer walls of the left ladder tube 2 and the right ladder tube 3. When the left ladder tube 2 and the right ladder tube 3 move upward, the lower insertion holes 15 at the lower ends of the left ladder tube 2 and the right ladder tube 3 are flush with the insertion rod 6, and in this case, a space is generated in front of the insertion rod 6, and the elastic member 7 pushes the insertion rod 6 to move outward.

Preferably, an upper pull rod 24 is arranged above the ladder body 1, the left ladder tube 2 and the right ladder tube 3 on both sides of the upper pull rod 24 are arranged in the left ladder tube 2 and the right ladder tube 3 on both sides of the lower crossbar pedal 4, and the left ladder tube 2 and the right ladder tube 3 on both sides of the upper pull rod 24 are driven to move upward by pulling the upper pull rod 24 upward. When the lower insertion holes 15 at the lower ends of the left ladder tube 2 and the right ladder tube 3 on both sides of the upper pull rod 24 are flush with the insertion rod 6 in the lower crossbar pedal 4, the insertion rod 6 of the lower crossbar pedal 4 moves outward and is inserted into the lower insertion holes 15. To open the present disclosure as needed, the upper pull rod 24 is directly pulled, and the left ladder tube 2 and the right ladder tube 3 on the upper pull rod 24 move upward. In this case, the lower insertion hole 15 is flush with the insertion rod 6 in the crossbar pedal 4 on a first layer, and the insertion rod 6 in the crossbar pedal 4 on the first layer is inserted into the lower insertion hole 15. In this case, after the insertion rod 6 is movably inserted into the lower insertion hole 15, the hook member 8 is driven to rotate, such that the insertion portion 11 is disengaged from the insertion slot 13. In this case, the crossbar pedal 4 on a second layer is not restricted by the crossbar pedal 4 on the first layer but is further pulled upward.

Preferably, a lower base rod 25 is further arranged below the ladder body 1, the locking assembly 5 is further arranged in the lower base rod 25, and a rotating member in the lower base rod 25 is manually driven to rotate so as to drive the insertion rod 6 to move transversely inward. In this case, the insertion rod 6 is disengaged from the lower insertion holes 15 of the left ladder tube 2 and the right ladder tube 3 on an upper layer of the lower base rod 25. In this case, the upper crossbar pedal 4 moves downward along with the left ladder tube 2 and the right ladder tube 3 on both sides. When contraction is required, the locking assembly 5 on the lower base rod 25 is manually pulled such that the insertion rod 6 on the lower base rod 25 is disengaged from the lower insertion holes 15 at the lower ends of the left ladder tube 2 and the right ladder tube 3 on the upper layer. The upper left ladder tube 2 and the upper right ladder tube 3 move downward to be sleeved into the lower left ladder tube 2 and the lower right ladder tube 3, and in this case, the abutment portion 14 on the upper crossbar pedal 4 is pushed by the connecting part 12 on the lower crossbar pedal 4 to drive the hook member 8 to rotate. With the natural downward movement due to gravity or weight, the contraction is completed layer by layer, without need to manually unlock layer by layer.

Preferably, an observation window 26 is further arranged on one side of the crossbar pedal 4 in a penetrating manner, such that the user clearly observes whether the insertion rod 6 of each layer and the lower insertion rod 6 are in a penetrating state. When the insertion rod 6 moves inward, the user sees the upper end of the rotated hook member 8 through the observation window 26, and when the insertion rod 6 is inserted into the lower insertion hole 15, the user sees only the insertion rod 6 through the observation window 26.

The above are merely preferred examples of the present disclosure and are not intended to limit the protection scope of the present disclosure. Therefore, any equivalent changes made based on the structure, shape and principles of the present disclosure shall fall within the protection scope of the present disclosure.

What is claimed is:

1. A telescopic ladder, comprising a ladder body, wherein the ladder body comprises a plurality of layers of left ladder tubes and right ladder tubes sleeved with each other, the upper left ladder tube and the upper right ladder tube are sleeved in the lower left ladder tube and the lower right ladder tube, each layer of the left ladder tube and the right ladder tube is provided with a crossbar pedal, and both ends of the crossbar pedal on each layer are connected to the left ladder tube and the right ladder tube on each layer;
a locking assembly is arranged in the crossbar pedal, and the locking assembly comprises an insertion rod movably arranged in the crossbar pedal and abutting against outer walls of the left ladder tube and the right ladder tube, an elastic member with one end connected to the insertion rod, and a hook member movably connected to the insertion rod, wherein the hook member is partially exposed on a lower surface of the crossbar pedal; a rotating groove is formed in the crossbar pedal, the hook member is provided with a rotating rod in a protruding manner, the hook member is arranged in the rotating groove through the rotating rod and rotates around the rotating rod, an upper end of the hook member is connected to the insertion rod and drives the insertion rod to move transversely outward or inward through rotation, and an insertion portion is arranged at a lower end of the hook member; a connecting part is arranged at an upper end of the crossbar pedal in a protruding manner, and an insertion slot is formed on the connecting part; when the upper left ladder tube and the upper right ladder tube move downward to be sleeved into the lower left ladder tube and the lower right ladder tube, the hook member rotates to drive the insertion portion to insert into the insertion slot, and in this case, the insertion rod in the lower crossbar pedal abuts against the outer walls of the upper left ladder tube and the upper right ladder tube, thereby preventing the insertion portion from disengaging from the insertion slot; an abutment portion is further arranged at a lower end of the hook member, after the upper left ladder tube and the upper right ladder tube move downward, the abutment portion on the upper hook member in the upper crossbar pedal abuts against the connecting part on the lower crossbar pedal, the upper crossbar pedal continues to move downward, and in this case, the connecting part on the lower crossbar pedal pushes the abutment portion of the upper hook member to rotate inward; in this case, the hook member in the upper crossbar pedal rotates around the rotating rod and drives the insertion portion to insert into the insertion slot in the connecting part of the lower crossbar pedal, and the insertion rod, driven by the rotation of the upper end of the hook member, moves transversely inward to mechanically compress the elastic member; and
lower insertion holes are formed at lower ends of the left ladder tube and the right ladder tube, when the upper crossbar pedal is pulled upward, the upper left ladder tube and the upper right ladder tube move upward, when the lower insertion holes at lower ends of the upper left ladder tube and the upper right ladder tube are flush with the insertion rod in the lower crossbar pedal, the insertion rod in the lower crossbar pedal is released, moves outward, and is inserted into the lower insertion hole, the hook member rotates around the rotating rod and drives the insertion portion to disengage from the insertion slot, and in this case, the upper crossbar pedal is pulled away from the lower crossbar pedal.

2. The telescopic ladder according to claim 1, wherein a snap-fit portion is arranged at a middle of the insertion rod, a diameter of the snap-fit portion is smaller than a diameter of both ends of the insertion rod, clamping portions are arranged at the upper end of the hook member, the number of the clamping portions is two, and the two clamping portions are arranged adjacent to each other and clamp the snap-fit portion.

3. The telescopic ladder according to claim 2, wherein the hook member is further provided with a pushing portion, and when the clamping portion is connected to the snap-fit portion, the pushing portion abuts against the insertion rod; when the abutment portion on the upper crossbar pedal is pushed by the connecting part on the lower crossbar pedal, the hook member rotates together with the rotating rod and pushes the insertion rod to move inward through the pushing portion; and in this case, one end of the insertion rod is disengaged from the lower insertion hole.

4. The telescopic ladder according to claim 1, wherein a sliding inclined surface is further arranged at an upper end of the connecting part, a sliding surface is further arranged between the abutment portion and the insertion portion, and when the connecting part on the lower crossbar pedal pushes the abutment portion on the upper hook member to rotate inward, the sliding surface is in contact with the sliding inclined surface.

5. The telescopic ladder according to claim 1, wherein the crossbar pedal is provided with a mounting groove, a mounting base is arranged in the mounting groove, a mounting hole is formed on the mounting base, and one end of the elastic member and one end of the insertion rod are arranged in the mounting hole, wherein one end of the elastic member abuts against the mounting hole, and the other end of the elastic member abuts against an end portion of the insertion rod; when the left ladder tube and the right ladder tube move upward and the lower insertion holes on the left ladder tube and the right ladder tube are flush with the insertion rod, the elastic member pushes the insertion rod to move outward and insert into the lower insertion hole; in this case, the upper left ladder tube and the upper right ladder tube cannot move into the lower left ladder tube and the lower right ladder tube; and the elastic member is a spring.

6. The telescopic ladder according to claim 1, wherein an upper pull rod is arranged above the ladder body, the left ladder tube and the right ladder tube on both sides of the upper pull rod are arranged in the left ladder tube and the right ladder tube on both sides of the lower crossbar pedal, and the left ladder tube and the right ladder tube on both sides of the upper pull rod are driven to move upward by pulling the upper pull rod upward; and when the lower insertion holes at the lower ends of the left ladder tube and the right ladder tube on both sides of the upper pull rod are flush with the insertion rod in the lower crossbar pedal, the insertion rod of the lower crossbar pedal moves outward and is inserted into the lower insertion holes.

7. The telescopic ladder according to claim 1, wherein a lower base rod is further arranged below the ladder body, the locking assembly is further arranged in the lower base rod, and a rotating member in the lower base rod is manually driven to rotate so as to drive the insertion rod to move transversely inward; in this case, the insertion rod is disengaged from the lower insertion holes of the left ladder tube and the right ladder tube on an upper layer of the lower base rod; and in this case, the upper crossbar pedal moves downward along with the left ladder tube and the right ladder tube on both sides.

8. The telescopic ladder according to claim 1, wherein an observation window is further arranged on one side of the crossbar pedal in a penetrating manner.
